(19) United States
(12) Patent Application Publication
(10) Pub. No.: US 2006/0193308 A1
(43) Pub. Date: Aug. 31, 2006

(54) Providing packet communication service

(76) Inventor: Jung-Sic Sung, Yongin-si (KR)

Correspondence Address: Robert E. Bushnell, Suite 300, 1522 K Street, N.W., Washington, DC, 20005, US

(21) Appl. No.: 11/349,240

(22) Filed: Feb. 8, 2006

(30) Foreign Application Priority Data
Feb. 28, 2005 (KR) 10-2005-0016827

(51) Int. Cl. H04L 12/66

(52) U.S. Cl. 370/352; 370/401

(57) ABSTRACT

A system and method of providing a packet communication service, in which when a voice call is established between IP terminals connected to the same private network, each IP terminal can exchange a packet through private IP address information and private port information assigned to the private network connected to each P terminal, so that packet transmission delay can be minimized and IP network resources can be used efficiently.

### CLAIM OF PRIORITY

This application makes reference to, incorporates the same herein, and claims all benefits accruing under 35 U.S.C. §119 from an application for SYSTEM AND METHOD FOR PROVIDING PACKET COMMUNICATION SERVICE filed in the Korean Intellectual Property Office 28 Feb. 2005 and there duly assigned Ser. No. 10-2005-0016827.

### BACKGROUND OF THE INVENTION

1. Field of the Invention

The present invention relates to providing a packet communication service. More particularly, the present invention relates to a system and method of providing a packet communication service, in which when a voice call is established between IP terminals connected to a common private network in a network having a plurality of private networks, packets can be exchanged by each IP terminal through private IP address information and port information used in the corresponding private network.

2. Description of the Related Art

Today, with increasing widespread use of the Internet, there is increased interest in Voice over Internet Protocol (VoIP) service.

By embodying an integrated telephone service using an IP network, the VoIP service provides telephone users with long distance calling and international direct dialing service via the Internet or an Intranet environment at the same cost as local calling. In VoIP, protocols such as Session Initiation Protocol (SIP), Media Gateway Control Protocol (MGCP), and H.323 are defined.

The SIP is an application layer control protocol based on simple text, in which one or more participants can generate/correct/terminate a session with one another. The session can be a teleconference, a telephone call, an event notification, an instant message, etc., using the Internet.

The MGCP, also known as “H.248” or “Megaco”, is a standard protocol for signal operation and session management needed during a multimedia conference.

The H.323 is a standard defined in “ITU-T” for transmitting video conference data through a network of a packet switching scheme such as TCP/IP.

Meanwhile, since new public IP addresses based on the IPv4 address system are running out as the number of Internet users continues to increase, a method of solving a shortage of public IP address by introducing a private IP address system using a technique such as Network Address Translation (NAT) has been introduced.

NAT is proposed to solve the problem of shortage of public IP address by enabling a large number of Internet users to use a small number of public IP addresses in an IP network, as explained in a general agreement of “Request for Comments (RFC) 1631”.

IP networks including a general private network include a private network using a private IP address, a public network using a public IP address, a network address converter for converting a private IP address used in the private network into a corresponding public IP address, and a switching system.

If a user wishes to use the VoIP service through a private IP terminal in the IP network, a manager has to set up public IP addresses which are mapped 1:1 to private IP addresses of each IP terminal in a switching system to connect a voice call between private IP terminals.

Furthermore, the private IP terminal sets up a source IP address as a private IP address according to telephone number information input by the user, generates a call request message whose receiving IP address is set up as a public IP address of the switching system, and transmits the message to the IP network.

The network address converter converts the IP address set up as the source IP address of the call request message received from the private IP terminal into a corresponding public IP address and transmits it to the switching system.

The switching system recognizes the receiving IP address of the call request message received from the network address converter and transmits the call request message to the receiving IP address.

When the receiving IP terminal responds to the call request message, voice calls between IP terminals included in different private networks are set up by way of the switching system and a voice call service based on the VoIP is provided.

However, such a method for providing voice call service has a drawback in that the public IP address corresponding to the private IP address of the IP terminal included in the private network is available only when it is directly mapped to the network address converter.

Furthermore, packets exchanged between IP terminals pass through the switching system after the voice call between IP terminals included in different private networks is set up through the switching system. Thus, there is a problem of switching system resources being wasted.

Generally, the switching system includes a Message Control Program (MCP) for controlling a voice call of each IP terminal and a Media Gateway Interface (MGI) for managing packets exchanged between IP terminals.

Accordingly, after a voice call between the IP terminals is set up through an MCP of the switching system, packets are exchanged through an MGI. Such an MGI is generally formed of a card having 16 ports. Since a task is performed where packets received from an IP terminal in the form of Real-time Transport Protocol (RTP) data are converted into packets of Pulse Code Modulation (PCM) data and then back into packets of RTP data, there is a packet transmission delay and sound quality deteriorates during the course of data conversion.

In addition, since the MGI is a card having 16 ports, ports through which packets are exchanged between IP terminals are occupied when calls are set up between a plurality of IP terminals, resulting in a waste of channel resources in the media gateway processor.

As technology for providing telephone service over the Internet develops, there is increasing interest in an Internet video telephone service through which video packets of video information are exchanged between IP terminals.

Accordingly, there is need for a method of directly exchanging voice packets of voice information and video packets of video information between IP terminals without passing through a switching system, by setting up a voice call for voice communication between IP terminals included in different private networks.

### SUMMARY OF THE INVENTION

It is an object of the present invention to provide a system and method of providing a packet communication service in a network system in which when a voice call is established between IP terminals connected to a common private network in a network having a plurality of private networks, packets can be exchanged through private IP address information and private port information assigned to the private network connected to each IP terminal.

According to one aspect of the present invention, a system is provided including: a first IP terminal adapted to transmit a call request message including identification information assigned to a connected private network, and to exchange a packet according to either address information or port information included in a received information provision message; a second IP terminal adapted to transmit a response message including the identification information assigned to the connected private network to a switching server, and to exchange a packet according to either the address information or port information included in the information provision message, in response to receiving the call request message; and the switching server adapted to transmit the information provision message including either the address information or port information to each IP terminal upon the identification information included in the call request message and the identification information included in the response message being the same, while managing the identification information assigned to each private network, and managing either address information or port information used upon each IP terminal exchanging the packet.

The system preferably further includes at least one router adapted to convert either private address information or private port information included in the packet received from the private network into corresponding public address information or public port information, and to convert either public address information or public port information included in the packet received from a public network into corresponding private address information or private port information.

Each IP terminal preferably includes: a memory adapted to store the address information assigned in the network, the port information to exchange the packet, and the identification information assigned to the connected private network; a message processor adapted to transmit a test message to the switching server using the address information, the port information and the identification information stored in the memory, and to transmit the response message to the call request message received from the switching server after including the stored identification information in the response message; and a packet processor adapted to set up either address information or port information of an opposite IP terminal recognized in the information provision message received from the switching server as destination information of a generated packet.

The message processor is preferably adapted to generate at least one test message including either the port information, the address information or the identification information stored in the memory and to transmit the test message to the switching server.

The packet processor is preferably adapted to set up the destination information of the packet as either the address information or port information of the opposite IP terminal received from the switching server, and to set up the source information as either the address information or port information assigned in the connected private network.

The system preferably further includes: a user interface adapted to provide either a telephone number signal or voice signal based on a user's selection, and to output voice information based on the received voice signal; a video processor adapted to provide a video signal based on video information to be photographed, and to display video information based on the received video signal, in response to a voice call being set up to the opposite IP terminal; and a controller adapted to generate a packet based on either the provided voice signal or video signal, and to transmit the voice signal or video signal included in the packet received from the opposite IP terminal to the user interface or video processor.

The switching server preferably includes: a database adapted to store telephone number information of each IP terminal, identification information solely assigned to each private network, and private address information and private port information used in the private network; and an information transmitter adapted to transmit either the private address information or private port information of the second IP terminal to the first IP terminal and either the private address information or private port information of the first IP terminal to the second IP terminal upon the identification information included in the call request message received from the first IP terminal and the identification information included in the response message received from the second IP terminal being the same.

The information transmitter is preferably adapted to transmit a first information provision message including either the private address information or private port information of the first IP terminal to the second IP terminal and a second information message including either the private address information or private port information of the second IP terminal to the first IP terminal, upon the identification information of the first IP terminal included in the call request message and the identification information included in the response message received from the second IP terminal being the same.

The information transmitter is preferably adapted to transmit the information provision message to the first and second IP terminals, upon the public address information set as source address information of the call request message received from the first IP terminal and public address information corresponding to the receiving telephone number information being the same.

The address information preferably includes at least one of the private IP address information used in each private network and the public IP address information used in the public network.

The port information preferably includes at least one of signaling port information for exchanging a signaling packet to set up a voice call, voice packet port information for exchanging a voice packet of voice information, and video packet port information for exchanging a video packet of video information.

The switching server is preferably connected to one of a plurality of private networks that are connected to each IP terminal.

According to another aspect of the present invention, a switching server of a network including at least one IP terminal connected to a public network through a plurality of private networks is provided, the switching server including: a database adapted to store telephone number information, identification information, public address information, private address information, each port information, and private address information and private port information corresponding to identification information of each private network of each IP terminal connected through each private network; and an information transmitter adapted to transmit a call request message received from a first IP terminal to a second IP terminal, and to transmit an information provision message including private address information and private port information corresponding to the identification information of each IP terminal to each IP terminal upon the identification information of the first IP terminal and the identification information of the second IP terminal being the same.

According to still another aspect of the present invention, a method of providing a service in a packet communication system including at least one IP terminal connected to a public network through private networks that are different from one another and a switching server is provided, the method including: managing, at the switching server, identification information of each private network and either address information or port information of each IP terminal using an information table; recognizing, at the switching server, identification information from a call request message received from a first IP terminal, and then transmitting the identification information to a second IP terminal; transmitting, at the second IP terminal, a response message to the received call request message including identification information of the connected private network to the switching server; and transmitting, at the switching server, either the address information or port information of the second IP terminal to the first IP terminal while transmitting either the address information or port information of the first IP terminal to the second IP terminal, upon the identification information of the first IP terminal and the identification information of the second IP terminal being the same.

The address information preferably includes at least one of private IP address information used in each private network and public IP address information used in the public network.

The port information preferably includes at least one of signaling port information for exchanging a signaling packet to set up a voice call, voice packet port information for exchanging a voice packet of voice information, and video packet port information for exchanging a video packet of video information.

The method preferably further includes: generating, at each IP terminal, a test message including private address information, private port information and identification information assigned from the connected private network, and then transmitting the test message to the network; converting the private information and private port information included in the test message into corresponding public address information and public port information, and transmitting the converted information to the switching server; and generating, at the switching server, an information table based on the address information, the port information and the identification information of each IP terminal included in the test message.

The method preferably further includes: generating, at the switching server, a first information provision message including either the private address information or private port information of the first IP terminal, and transmitting the message to the second IP terminal, upon the identification information of the first IP terminal and the identification information of the second IP terminal being the same; and generating, at the switching server, a second information provision message including either the private address information or private port information of the second IP terminal, and transmitting the message to the first IP terminal.

The method preferably further includes: recognizing, at the switching server, the address information of the first IP terminal included in the received call request message; recognizing the address information of the second IP terminal based on a receiving telephone number of the call request message; searching for private address information or private port information corresponding to the address information of the first IP terminal or the second IP terminal upon the address information of the first IP terminal and the address information of the second IP terminal being the same; and generating an information provision message including the searched private address information or private port information, and transmitting the message to each IP terminal.

The address information preferably includes public IP address information used by each IP terminal in the public network.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings, in which like reference symbols indicate the same or similar components, wherein:

FIG. 1 is a block diagram of the overall configuration of an IP network including a number of private networks;

FIG. 2 is a block diagram of the internal configuration of an IP terminal in accordance with an exemplary embodiment of the present invention;

FIG. 3 is a diagram of a configuration of a packet;

FIG. 4 is a block diagram of the internal construction of a router in accordance with an exemplary embodiment of the present invention;

FIG. 5 is a NAT table of a router in accordance with the present invention;

FIG. 6 is a block diagram of the internal construction of a switching system in accordance with an exemplary embodiment of the present invention;

FIG. 7 is a terminal information table in accordance with an exemplary embodiment of the present invention;

FIG. 8 is a private information table in accordance with an exemplary embodiment of the present invention;

FIG. 9 is a flowchart of a method of providing a video Internet telephone service in an exemplary embodiment of the present invention;

FIGS. 10A to 10F are respective a link test messages in accordance with an exemplary embodiment of the present invention; and

FIG. 11 is a view of a method of providing an Internet telephone service in accordance with an exemplary embodiment of the present invention.

### DETAILED DESCRIPTION OF THE INVENTION

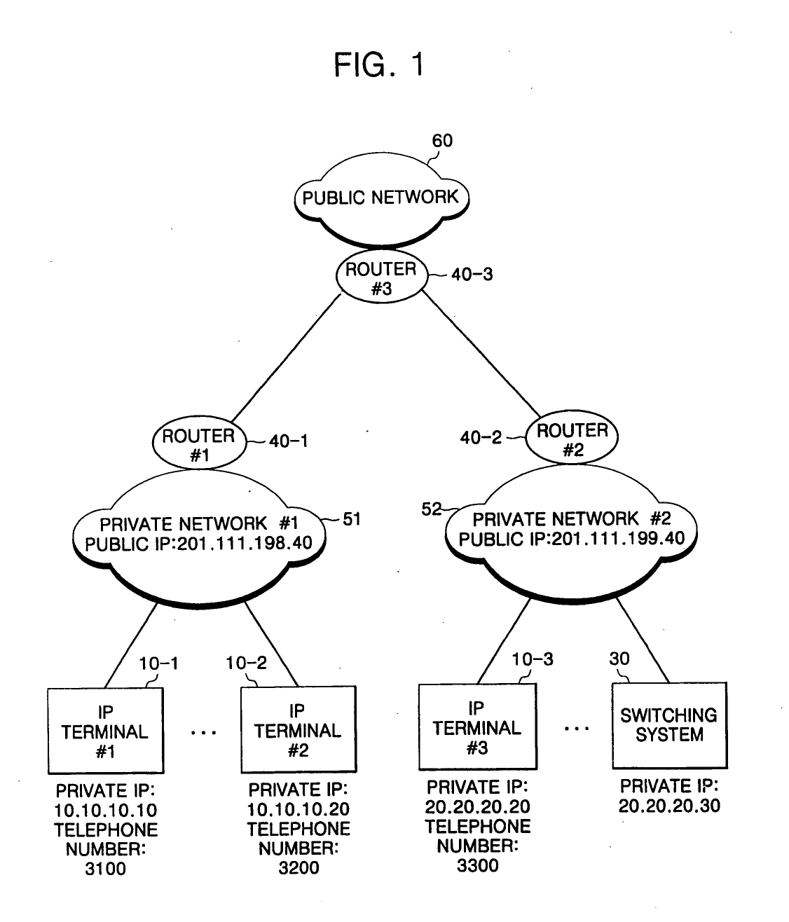

FIG. 1 is a block diagram of the overall configuration of an IP network including a number of private networks. Referring to FIG. 1, the IP network includes a number of IP terminals 10-1, 10-2 and 10-3 connected to a number of private networks 51 and 52, a public network 60 connected to each of private networks 51 and 52 using assigned public IP addresses, a switching system 30 for setting up a voice call between the IP terminals 10-1, 10-2 and 10-3 included in each of the private networks 51 and 52 and a number of routers 40-1, 40-2, and 40-3.

The public network 60 refers to a network to which each of terminals 10- 1, 10-2 and 10-3 is connected using the public IP address, and the public IP address used in the public network 60 is unique in the world which is assigned and used by domestic and oversea IP address management institutes.

Hereinafter, although the present invention is described with reference to the case where a public IP address is a 32-bit IP address based on an IPv4 address system, the same principles also apply to the case where the public IP address is a 128-bit public IP address based on an IPv6 address system.

Furthermore, in the private networks 51 and 52, the IP terminals 10- 1, 10-2 and 10-3 use private IP addresses intended for use in a unit or other organization only.

The routers 40-1, 40-2, and 40-3 route packets of received voice information and video information, and transmit corresponding packets to a destination.

Furthermore, each of routers 40-1 and 40-2 connected to the private networks 51 and 52 converts source IP addresses transmitted from the IP terminals 10-1, 10-2 and 10-3 into corresponding public IP addresses, and destination IP addresses of packets received from the public network 60 into corresponding private IP addresses. That is, each of the routers 40-1 and 40-2 converts a private IP address included in a packet into a corresponding public IP address, and a public IP address into a corresponding private IP address, according to a network address translation function.

Furthermore, the routers 40-1 and 40-2 transmit received packets to the destination IP terminals 10-1, 10-2 and 10-3 using the IP address information and port information of each of the IP terminals 10-1, 10-2 and 10-3 while managing port information with which the IP terminals 10-1, 10-2 and 10-3 exchange packets and IP address information of each of the IP terminals 10-1, 10-2 and 10-3.

When receiving a call request message from the IP terminals 10-1, 10-2 and 10-3, the switching system 30 recognizes receiving IP terminals 10-1, 10-2 and 10-3 and exchanges to set up a voice call between the calling IP terminals 10-1, 10-2 and 10-3 and receiving IP terminals 10-1, 10-2 and 10-3 through an IP network. That is, the switching system 30 performs a switching server function to control a voice call of each of IP terminals 10-1, 10-2 and 10-3.

Furthermore, when the switching system 30 has a calling IP terminal and a receiving IP terminal of a receiving call request message connected to the same private networks 51 and 52 while managing each IP address information, port information for exchanging each packet, and specific identification information assigned to each private networks 51 and 52 such as private ID information, it transmits private IP address information and private port information used by the counterpart IP terminal in the private networks 51 and 52 to each of the IP terminals 10-1, 10-2 and 10-3.

The private ID information assigned to each of the private networks 51 and 52 can assign specific ID information to each of the private networks 51 and 52 connected to a router 40 to which public IP address information is assigned, or the same ID information to a plurality of private networks 51 and 52 connected to at least one router 40.

Furthermore, each of the IP terminals 10-1, 10-2 and 10-3 connected to the private networks 51 and 52 to which the same private ID information is assigned arbitrarily designates private address information and private port information to exchange packets in the private networks 51 and 52, so that each of the IP terminals 10-1, 10-2 and 10-3 can exchange the packets in the private networks 51 and 52. As such, a system manager can directly setup private address information and private port information with which each of the IP terminals 10-1, 10-2 and 10-3 exchanges the packets in the private networks 51 and 52 in the switching system 30.

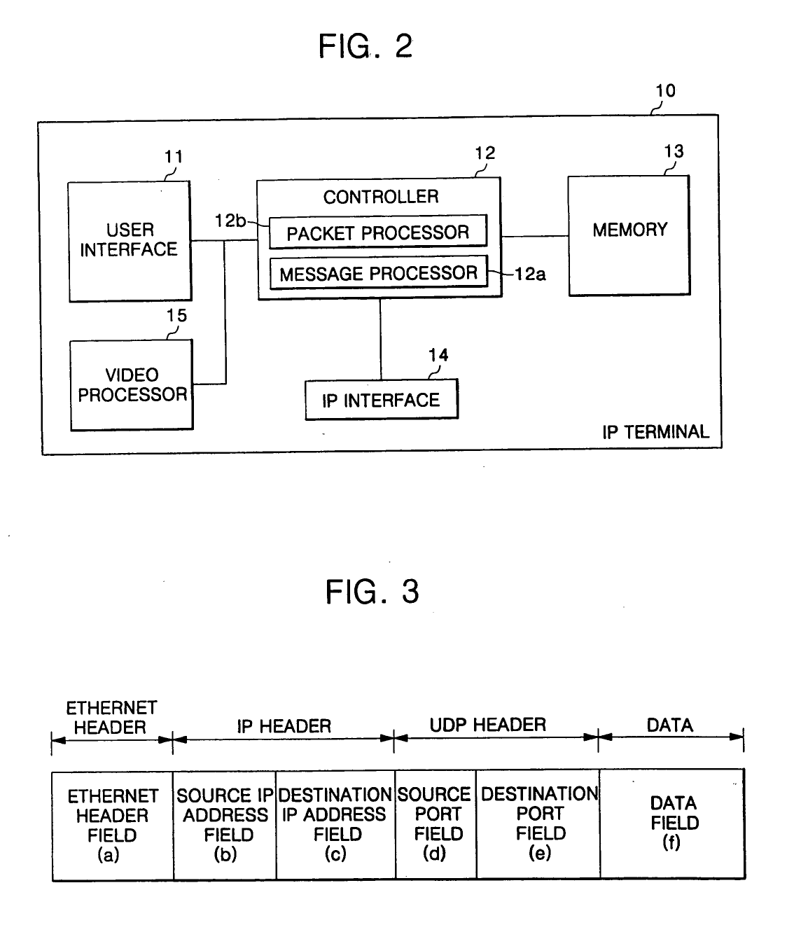

FIG. 2 is a block diagram of the internal configuration of an IP terminal in accordance with an exemplary embodiment of the present invention. Referring to FIG. 2, an IP terminal 10 of the present invention includes a user interface 11, a controller 12, a memory 13, a video processor 15 and an IP interface 14. The controller 12 includes a message processor 12a and a packet processor 12b.

The user interface 11 provides an input signal based on telephone number information selected by the user, and provides the controller 12 with a voice signal of voice information input by the user.

Furthermore, the user interface 11 outputs voice information based on the voice signal received from the opposite IP terminal 10 where a voice call is set up so that the user can listen to the voice information.

The video processor 15 can be a camera (not shown) for taking a video and a display (not shown) for displaying an image. It takes an image of an anterior view of the camera and provides the controller 12 with a video signal when a voice call is set up in the IP terminal 10, and displays the video based on the video signal received from the controller 12 through the display.

The memory 13 stores public or private IP address information assigned to the IP terminal 10, operation information of the IP terminal 10, and each of port information with which the packets are exchanged and private ID information assigned to the private network connected to the IP terminal 10. The port information of the IP terminal can correspond to signaling port information to exchange a signaling packet used to set up the voice call, voice port information to exchange the voice packet based on the voice signal, and video port information to exchange the video packet based on the video signal.

Furthermore, the message processor 12a of the controller 12 generates a call request message according to an input signal provided from the user interface 11 and transmits it to the opposite IP terminal 10. Furthermore, when a voice call is connected to the opposite IP terminal 10, the message processor 12a of the controller 12 generates a voice packet based on the voice signal provided from the user interface 11 and a video packet based on the video signal provided from the video processor 15, and transmits them to the opposite IP terminal 10. The message processor 12a includes private ID information in a call request message or response message.

Furthermore, the packet processor 12b setups private IP address information and private port information of the opposite IP terminal recognized in the received call request message, response message or information provision message as destination information of the voice packet or video packet. Accordingly, each packet generated in the packet processor 12b can be directly transmitted to the opposite IP terminal connected to the same private network.

The packet processor 12b can compress the generated voice packet according to a standard such as “G.729” or “G.723”, and compress the video packet according to a standard such as “H.216” or “H.263”.

Furthermore, the controller 12 transmits a response message to a call request message received from the opposite IP terminal 10 to the switching system 30, and sets up a voice call to the opposite IP terminal 10.

When the IP terminal 10 is connected to the switching system 30 through an IP network, the message processor 12a generates a test message, for example, a link test message (LinkTestMsg) with a predetermined period and transmits it to the switching system 30.

Information included in the link test message can be telephone number information, IP address information, signaling port information, voice packet port information, video packet information and port type information of the corresponding IP terminal 10, and private ID information of the private networks 51 and 52 connected to the corresponding IP terminal 10.

Furthermore, the message processor 12a can periodically transmit to the switching system 30 a link test message including all of the private ID information, the signaling port information, the voice packet port information and video packet information, or periodically transmit to the switching system 30 each of a first link test message including the signaling port information, a second link test message including the voice packet port information, and a third link test message including the video packet port information.

Hereinafter, the following description of the present invention concerns the case in which the IP terminal 10 periodically transmits to the switching system 30 each of the first link test message including the private ID information and signaling port information, the second link test message including the private ID information and voice packet port information, and the third link test message including the private ID information and video packet port information.

The message processor 12a transmits a response message to the call request message received from the opposite IP terminal through the switching system 30, to the opposite IP terminal through the switching system 30.

FIG. 3 is a view of a configuration of a packet. As shown in FIG. 3, the packet can be divided into an Ethernet header area, an Internet Protocol (IP) header area, a User Datagram Protocol (UDP) header area, and a data area.

The IP header area includes a source IP address field (b) and a destination IP address field (c), and the UDP header area includes a source port field (d) and a destination port field (e).

The source IP address field (b) sets up 32-bit IP address information of the IP terminal 10 to transmit the packet, and the destination IP address field (c) sets up 32-bit IP address information of a final destination of the packet.

The source port field (d) has 16-bit port information used to transmit the packet in an application, and the destination port field (e) has 16-bit port information used to receive data in an application of the IP terminal that receives the packet.

The message processor 12a transmits a link test message generated with a predetermined period to the switching system 30 through adjacent routers 40-1 and 40-2.

That is, the message processor 12a sets up the private IP address information assigned to the IP terminal 10 from the private network 50 in the source IP address field (b) of the packet, the public IP address of the switching system 30 in the destination IP address field (c), the signaling port information in the source port field (d), the signaling port information of the switching system 30 in the destination port field (e), and port type information, private ID information and telephone number information of the source port field (d) in the data field (f), and generates a first link test message with a predetermined period.

Furthermore, the message processor 12a sets up private IP address information assigned to the IP terminal 10 from the private network 50 in the source IP address field (b) of the packet, public IP address of the switching system 30 in the destination IP address field (c), packet port information in the source port field (d), voice packet port information of the switching system 30 in the destination port field (e) and port type information and telephone number information of the source port field (d) in the data field (f), and generates a second link test message with a predetermined period.

Furthermore, the message processor 12a sets up private IP address information assigned to the IP terminal 10 from the private network 50 in the source IP address field (b) of the packet, public IP address of the switching system 30 in the destination IP address field (c), packet port information in the source port field (d), video packet port information of the switching system 30 in the destination port field (e), and port type information and telephone number information of the source port field (d) in the data field (f), and generates a third link test message with a predetermined period.

The IP interface 14 performs an interfacing operation to transmit the first, second and third link test messages generated by the message processor 12a to the switching system 30 through the IP network. Furthermore, the IP interface 14 transmits the call request message generated by the controller 12 according to the input signal provided from the user interface 11 to the opposite IP terminal 10 through the switching system 30, or receives the call request message from the opposite IP terminal 10 through the switching system 30.

Furthermore, the IP interface 14 performs an interfacing operation to transmit the voice packet generated by the controller 12 according to the voice signal provided from the user interface 11 and the video packet generated by the controller 12 according to the video signal provided from the video processor 15 when a call is set up with the opposite IP terminal 10, or transmits the voice packet and video packet received from the opposite IP terminal 10 through the IP network to the controller 12.

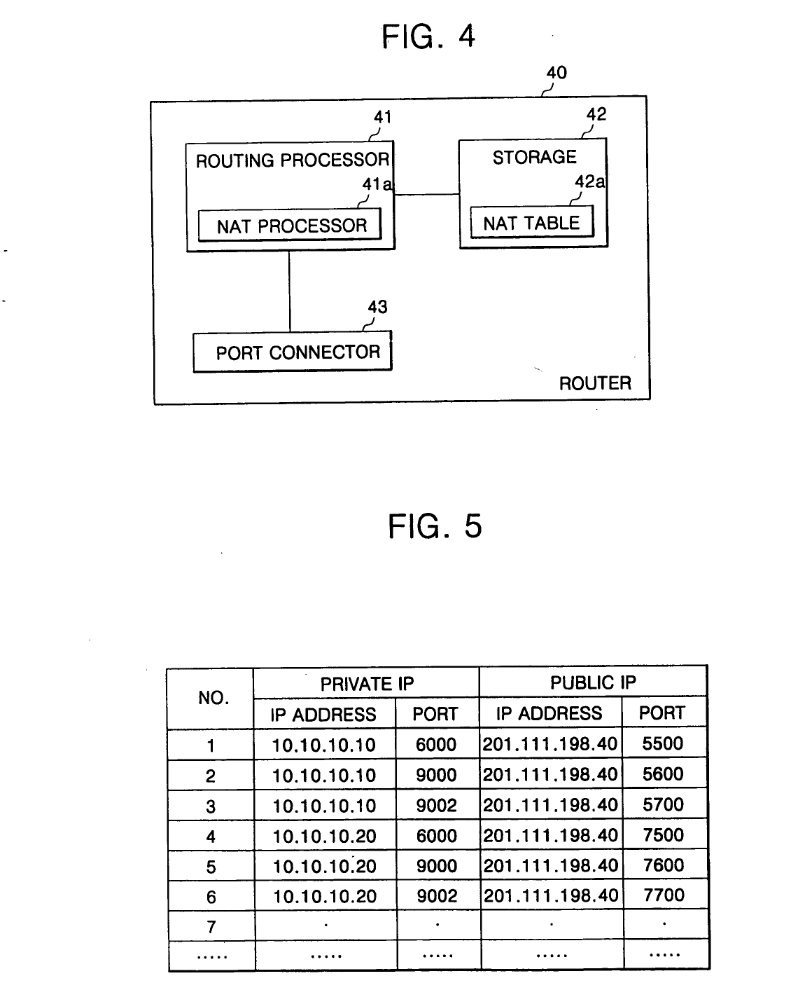

FIG. 4 is a block diagram of the internal construction of a router in accordance with an exemplary embodiment of the present invention. Referring to FIG. 4, the router 40 of the present invention includes a routing processor 41, a storage unit 42, and a port connector 43. The routing processor 41 includes a Network Address Translation (NAT) processor 41a, and the storage unit 42 stores an NAT table 42a.

The port connector 43 provides the routing processor 41 with the packet received from the IP terminals 10-1, 10-2 and 10-3 or the switching system 30 through the private networks 51 and 52 or the public network 60, and outputs the packet to a corresponding port according to a routing result of the routing processor 41.

The routing processor 41 searches for a path to transmit the packet to the final destination set up in a header of the packet provided from the port connector 43, from a forwarding table (not shown), and transmits the packet along the searched path.

That is, the routing processor 41 outputs the packet received according to port information with which each of the IP terminals 10-1, 10-2 and 10-3 exchanges the packet through the corresponding port.

The NAT processor 41a of the routing processor 41 searches for public IP address information corresponding to private IP address information included in the header of the packet received through the port connector 43 from the NAT table 42a and then converts the IP address of the packet into the searched public IP address. Otherwise, the NAT processor 41a searches for and converts the private IP address information corresponding to the public IP address information included in the header of the packet from the NAT table 42a.

The NAT table 42a of the storage unit 42 stores private IP address information of each of the IP terminals 10-1, 10-2 and 10-3 and port information used in the private networks 51 and 52, public IP address information of the private networks 51 and 52 including each of the IP terminals 10-1, 10-2 and 10-3, and port information used in the public network 60.

FIG. 5 is an NAT table of a router in accordance with the present invention. Referring to FIG. 5, the NAT table 42a stores private IP address information used in one of the private networks 51 and 52, private port information, public IP address information corresponding to the private IP address information, and public port information in the NAT table 42a. The port information can be signaling port information, voice packet port information, and video packet port information.

As an example, when the private IP terminal 10 whose private IP address is “10.10.10.10” has a signaling port of “6000”, a voice packet port of “9000”, and a video packet port of “9002”, the IP terminal 10 exchanges the packet to set up a voice call through a port number “6000”, the voice packet according to a voice signal through a port number “9000”, and a video packet according to a video signal through a port number “9002”.

The port connector 43 provides the routing processor 41 with the packet received from the IP terminal 10-1, 10-2 and 10-3, and the NAT processor 41 a searches for public IP address information and port information corresponding to the private IP address information and port information set up in the source IP address field (b) and source port field (d) of the packet received, from the NAT table 42a, and then converts them into public IP address information and port information.

That is, the NAT processor 41a converts the private IP address information into the public IP address information according to the network address conversion function, and port information used in the private network 51 into port information used in the public network 60, and transmits them to the public network 60.

The NAT processor 41a searches for private IP address information and port information corresponding to the public IP address information and port information set up in the source IP address field (b) and source port field (d) of the packet received through the public network 60, converts them into the private IP address information and port information, and transmits the converted information to the IP terminal 10 connected to the private network 51.

At the same time, the NAT processor 41a converts the public IP address information and public port information set in the destination IP address field (c) and destination port field (e) of the received packet into corresponding private IP address information and private port information, or the private IP address information and private port information into corresponding private IP address information and private port information.

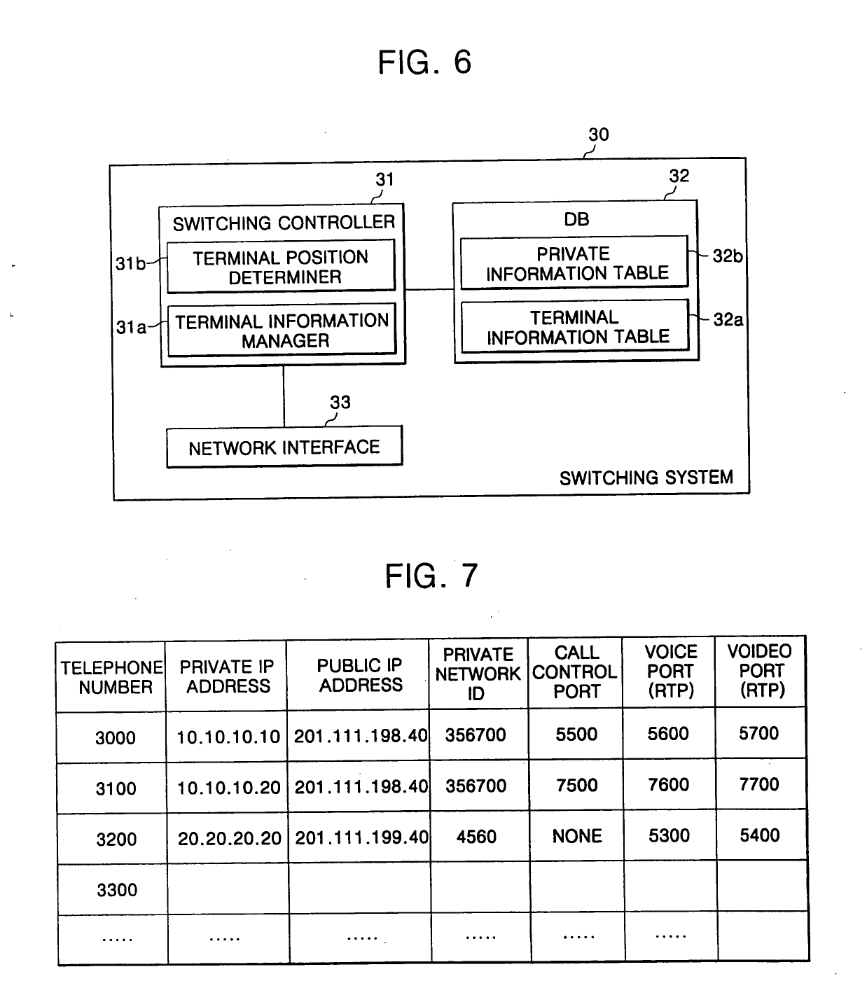

FIG. 6 is a block diagram of the internal configuration of a switching system in accordance with an exemplary embodiment of the present invention. Referring to FIG. 6, the switching system 30 of the present invention includes a switching controller 31, a network interface 33 and a database (DB) 32. The switching controller 31 includes a terminal information manager 31a and a terminal position determiner 31b. The database 32 stores a terminal information table 32a and a private information table 32b.

The network interface 33 provides the switching controller 31 with a packet received through the IP network, that is, each link test message, a call request massage, and a response message.

Furthermore, the network interface 33 performs a switching operation to set up a voice call between the IP terminals 10 and 20 according to the received call request message and response message of the switching controller 31. That is, the switching controller 31 performs a switching operation to transmit the call request message received through the network interface 33 to the received IP terminal, transmits a response message with respect to a call request message received from the received IP terminal to a calling IP terminal, and sets up a voice call.

The terminal information manager 31a of the switching controller 31 stores and manages private ID information, telephone number information, private IP address information, public IP address information, and each of port information of each of the IP terminals 10-1, 10-2 and 10-3 connected to the IP network in the terminal information table 32a.

That is, the terminal information manager 31a manages telephone number information, private IP address information, public IP address information, private ID information and each port information included in each link test message received through the network interface 33 using the terminal information table 32a.

Such a switching system 30 can recognize the IP address information and port information set up in a field of each of the received link test message through a parameter of a “recvform( )” command.

FIG. 7 is a terminal information table in accordance with an exemplary embodiment of the present invention. The terminal information table 32a of FIG. 7 corresponds to the case where the first IP terminal 10-1 and second IP terminal 10-2 are connected to the first private network 51. The terminal information table 32a stores telephone number information, private IP address information, public IP address information, private ID information, signaling port information (Call Control Port), voice packet port information (Voice Port), and video packet port information (Video Port) of each of the IP terminals 10-1, 10-2 and 10-3.

The terminal information manager 31 a recognizes each IP address information, private ID information and each port information of each of the IP terminals 10-1, 10-2 and 10-3 from each link test message received from each of the IP terminals 10-1, 10-2 and 10-3, and manages them through the terminal information table 32a.

The first, second, and third link test messages transmitted from one of the IP terminals 10-1, 10-2 and 10-3 have the same telephone number information and IP address information. It is desirable for one telephone number information and one IP address information to be stored in one of the IP terminals 10-1, 10-2 and 10-3, and for signaling port information, voice packet port information and video packet port information of the corresponding IP terminal 10-1, 10-2 and 10-3 to be stored, so that usage efficiency of the database 32 that is a storage area of the switching system 30 is maximized.

Furthermore, the terminal information manager 31a manages the private port information and private IP address information assigned to each of the private networks 51 and 52 through the private information table 32b. That is, when the voice call is established between a plurality of IP terminals connected to the same private networks 51 and 52, the private IP address and each port information of each of the private networks 51 and 52 that were established in advance are transmitted to each of the IP terminals 10-1, 10-2 and 10-3 so that each of the IP terminals 10-1, 10-2 and 10-3 can directly exchange packets in the private networks 51 and 52.

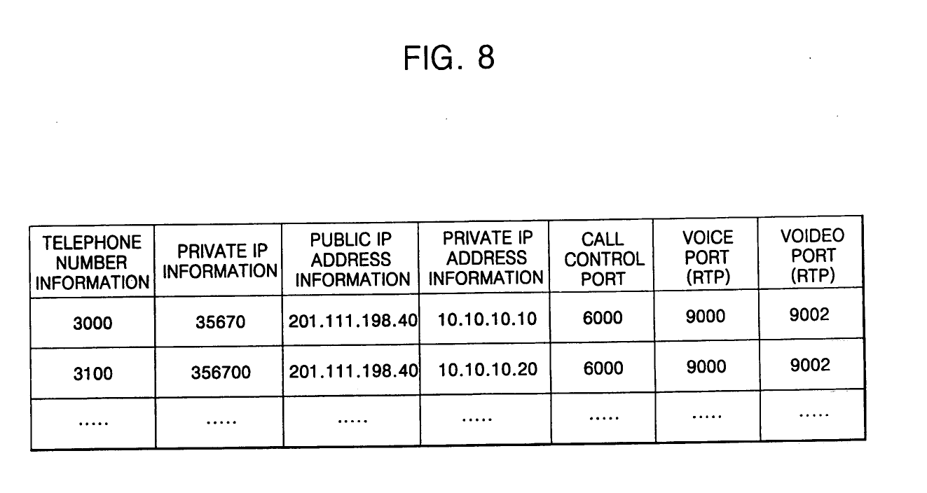

FIG. 8 is a private information table in accordance with an exemplary embodiment of the present invention. Referring to FIG. 8, the switching system 30 has telephone number information, private IP address information, public IP address information, private ID information and each of private port information of each of the IP terminals 10-1, 10-2 and 10-3.

As such, the private information table 32b can be included and stored in the terminal information table 32a, and each of the private port information is port information assigned to exchange a signaling packet, a voice packet and a video packet in each of the private networks 51 and 52.

For example, the private ID information based on the public IP address information of a first private network 51 is “3567000”, the signaling port information of the first private network 51 is ‘6000’, the voice packet port information is ‘9000’, and the video packet port information is ‘9002’.

Furthermore, the terminal position determiner 31b recognizes the receiving IP terminal 10-2 from the call request message that is received from the calling IP terminal 10-1, and then determines whether or not the calling IP terminal 10-1 and the receiving IP terminal 10-2 are connected to the same private network 51.

When it has been determined that the calling IP terminal 10-1 and the receiving IP terminal 10-2 are connected to the same private network 51, the terminal position determiner 31b transmits the private IP address information and each of the private port information stored in the private information table 32b to the calling IP terminal 10-1 and the receiving IP terminal 10-2.

That is, the calling IP terminal 10-1 transmits the call request message including the assigned private ID information to the switching system 30, and the terminal position determiner 31b of the switching system 30 determines that the calling IP terminal and the receiving IP terminal are connected to the same private network when the private ID information included in the call request message and the private ID information of the receiving IP terminal 10-2 are equal to each other.

When the calling IP terminal 10-1 does not include the private ID information in the call request message, the terminal position determiner 31b determines that the calling IP terminal 10-1 and the receiving IP terminal 10-1 are connected to the same private network 51 when the public IP address converted while passing through the router 40 is the same as the public IP address of the receiving IP terminal 10-2.

Furthermore, when the calling IP terminal 10-1 and the receiving IP terminal 10-2 are connected to the same private network 51, the terminal position determiner 31 b of the switching system 30 can search for the private IP address information and private port information assigned to the private network 51 to which the calling IP terminal 10-1 and the receiving IP terminal 10-2 are connected and then transmit them included in the call request message to the receiving IP terminal 10-2.

Furthermore, it is possible to include private IP address information and private port information assigned to the private network 51, to which the receiving IP terminal 10-2 is connected, into a response message received from the receiving IP terminal 10-2 and transmit the response message to the calling IP terminal 10-1.

On the other hand, the terminal position determiner 31b can recognize the public IP address information and public port information of the calling IP terminal 10-1 and the public IP address information and public port information of the receiving IP terminal 10-2 included in the call request message, establish the public IP address information and public port information of each of the IP terminals 10-1 and 10-2 as destination information, generate an information provision message including the private IP address information and private port information assigned to the corresponding private network 51, and transmit the information provision message to each of the IP terminals 10-1 and 10-2.

The information provision message transmitted to the calling IP terminal 10-1 includes the private IP address information and private port information of the receiving IP terminal 10-2, and the information provision message transmitted to the receiving IP terminal 10-2 includes the private IP address information and private port information of the calling IP terminal 10-1. It is desirable for the private port information of each of the IP terminals 10-1, 10-2 and 10-3 connected to the same private networks 51 and 52 to be established as the same port information.

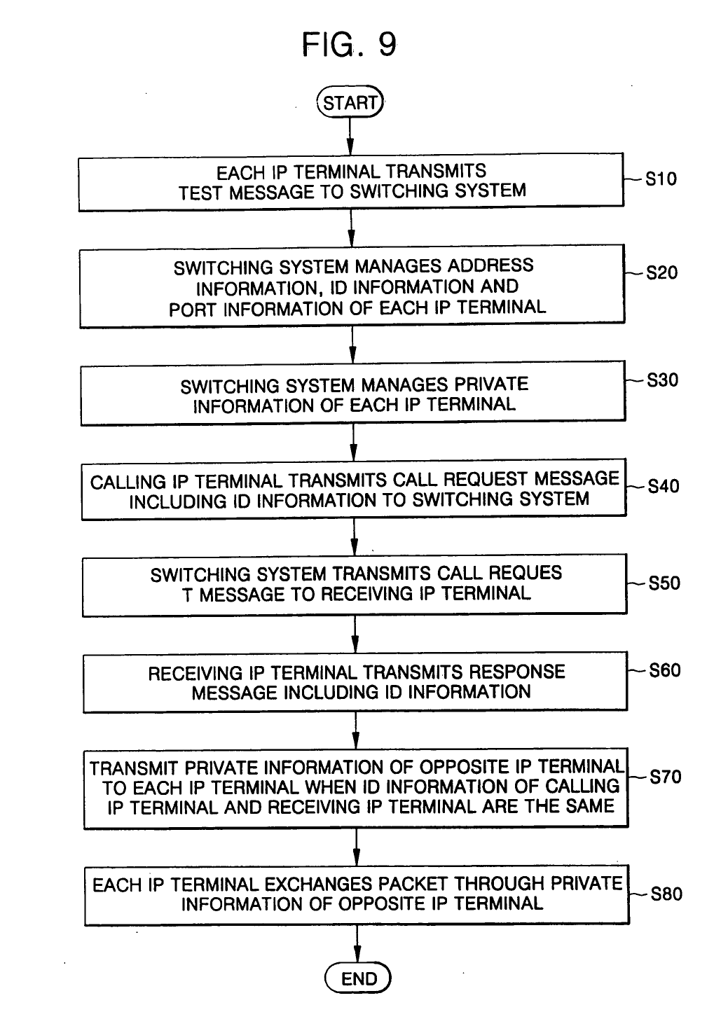

FIG. 9 is a flowchart of a method of providing a video Internet telephone service in accordance with an exemplary embodiment of the present invention. Referring to FIG. 9, when each IP terminal 10 is connected to an IP network, it transmits a link test message including port information, port type information and private ID information assigned to each of the private networks 51 and 52 to the switching system 30 through each of routers 40-1 and 40-2 interlocked to the IP terminal 10 (S10).

Each of the IP terminals 10-1 and 10-2 can periodically transmit the first, second and third link test messages including signaling port information, voice packet port information and video packet port information to the switching system 30.

Each of the routers 40-1 and 40-2 converts private IP address information and each port information of the private networks 51 and 52 set up in the source IP address field B and source port field D of each link test message received from each of the IP terminals 10-1, 10-2 and 10-3 into corresponding public IP address information of the public network 60 and port information used in the public network 60 and then transmits the converted information to the switching system 30.

For example, as shown in FIG. 1, the case will be explained where the first and second IP terminals 10-1 and 10-2 are connected to the same first private network 52.

The first IP terminal 10-1 generates the first, second and third link test messages including the signaling port information, voice packet port information and video packet port information and transmits the messages to the first router 40-1.

As shown in FIG. 1, when the private IP address of the first IP terminal 10-1 is “10.10.10.10”, the signaling port information is “6000”, the voice packet port information is “9000”, and the video packet port information is “9002”, the first router 40-1 stores an NAT table 42a as shown in FIG. 5.

When the first IP terminal 10 is connected to the IP network, it periodically transmits each link test message to the switching system 30 through the first router 40-1.

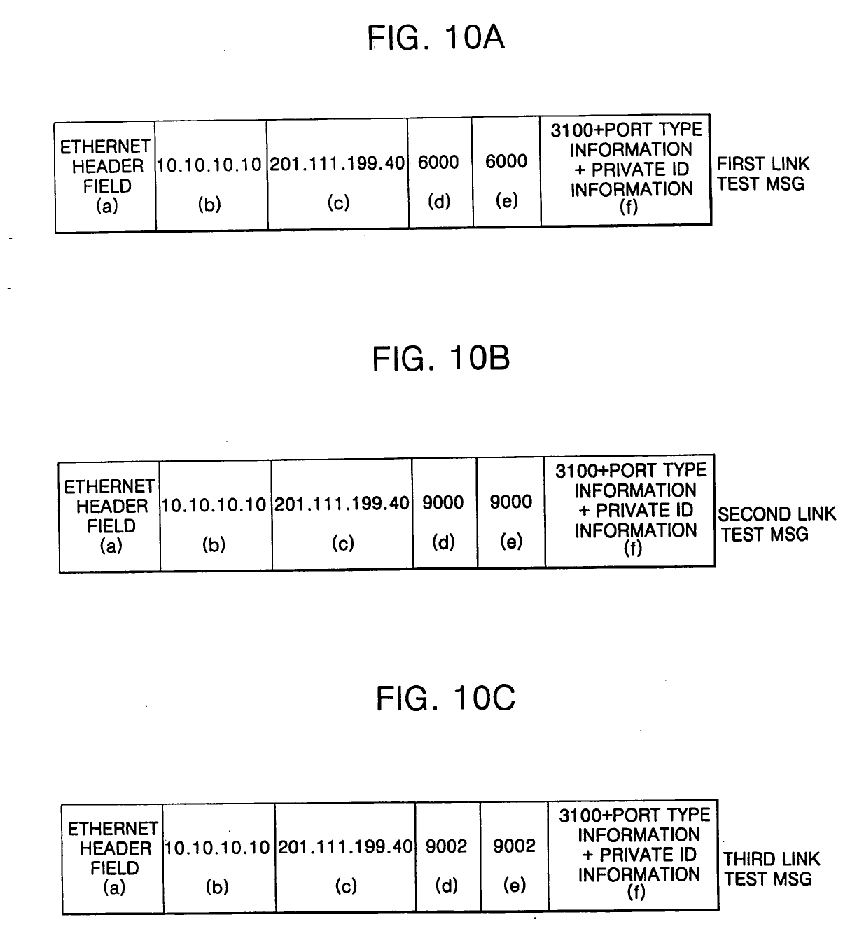

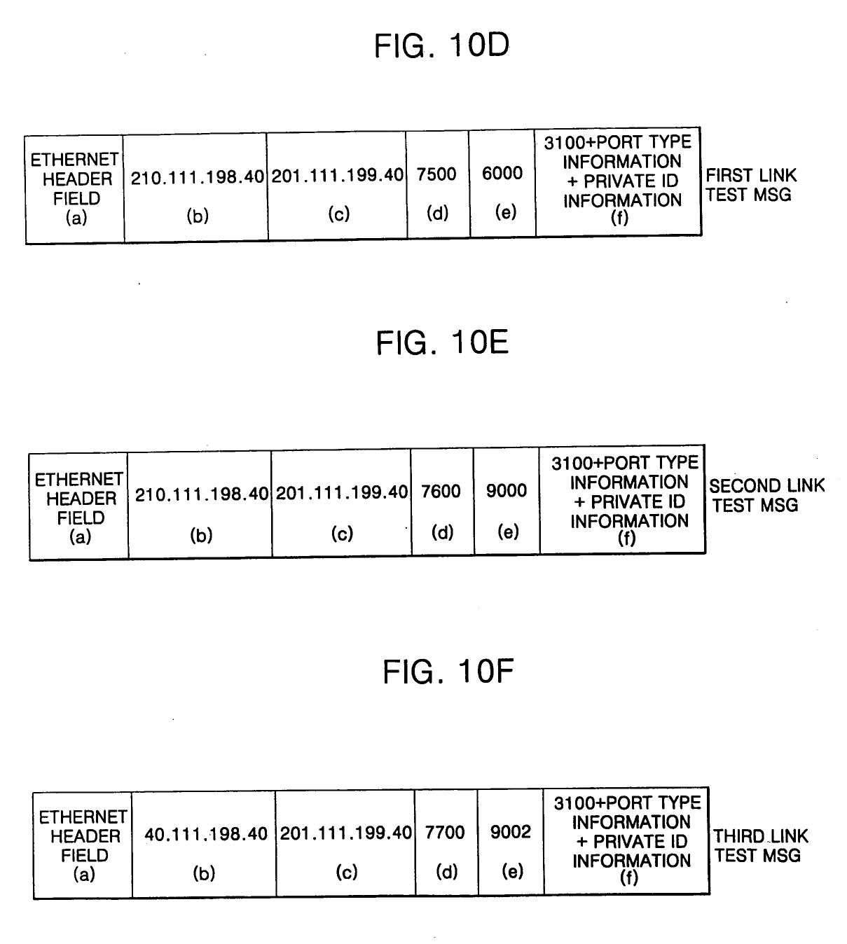

FIGS. 10A to 10F are respective link test messages in accordance with an embodiment of the present invention. FIGS. 10A to 10C show each link test message generated by the first IP terminal 10-1, wherein the message processor 12a of the first IP terminal 10-1 periodically transmits to the first router 40-1 a first link test message having a source IP address field (b) set with a private IP address of “10.10.10.10”, a destination IP address field (c) set with the public IP address of the second private network 52 of “201.111.199.40” including the switching system 30, a source port field (d) set with signaling port information of the first IP terminal 10-1 of “6000”, a destination port field (e) set with signaling port information of the switching system 30, and a data field (f) set with telephone number information of “3100”, port type information and private ID information of “356700” set in the source port field (d), as shown in FIG. 10A.

Furthermore, the message processor 12a of the first IP terminal 10-1 periodically transmits to the first router 40-1 a second link test message having a source IP address field (b) set with a public IP address of “10.10.10.10”, a destination IP address field (c) set with a public IP address of the second private network of “201.111.199.40” including the switching system 30, a source port field (d) set with voice packet port information of the first IP terminal 10-1 of “9000”, a destination port field (e) set with destination port information, and a data field (f) set with telephone number information of “3100”, port type information and private ID information of “356700” set up in the source port field (d), as shown in FIG. 10B.

Simultaneously, the message processor 12a of the first IP terminal 10-1 periodically transmits to the first router 40 a third link test message having a source IP address field (b) set with a private IP address of “10.10.10.10”, a destination IP address field (c) set with a public IP address of the second private network 52 of “201.111.199.40” including the switching system 30, a source port field (d) set with signaling port information of the first IP terminal 10 of “9002”, a destination port field (e) set with destination port information, and a data field (f) set with telephone number information of “3100, port type information and private ID information of “356700” set up in the source port field (d), as shown in FIG. 10C.

The NAT processor 40-1a of the first router 40 recognizes telephone number information, private IP address information and port type information of the first IP terminal 10-1 from the source IP field (b), source port field (d) and data field (f) of the first, second and third link test messages that are received through the port connector 43.

Furthermore, the NAT processor 40-1a searches for the private IP address information recognized in the NAT table 42a, public IP address information corresponding to the port information, and the port information, converts information set up in the source IP address field (b) and source port field (d) into the public IP address information and port information searched for in the NAT table 42a, and transmits the converted information to the switching system 30.

That is, the first router 40-1 converts the IP address information set up in the source IP address field (b) into the public IP address information of “210.111.198.40” corresponding to the private IP address information of “10.10.10.10”, and the port information set up in the source port field (d) into the signaling information of “5500” used in the public network 60 corresponding to the signaling port information of “6000” used in the first private network 51, and then transmits the first link test message received from the first terminal 10 to the switching network 30, as shown in FIG. 10D.

Furthermore, the first router 40-1 converts the IP address information set up in the source IP field (d) of the second link test message and the third link test message into the public IP address information of “201.111.198.40”, the port information of the source port field (d) of the second link test message into the voice packet port information of “5600” used in the public network 60, and the port information of the source port field (d) of the third link test message into the video packet port information of “5700” used in the public network 60, and then transmits the converted information to the switching system 30, as shown in FIGS. 10E and 10F.

The NAT processor 41a of the first router 40-1 can determine whether the port information set up in the source port field (d) of each link test message is the signaling port information, voice packet port information or the video port information by recognizing the port type information stored in the data field (f) of each link test message received.

The switching system 30 recognizes the IP address information and port information included in the source IP address field (b), source port field (d) and data field (f) in each link test message received from each of the IP terminals 10-1, 10-2 and 10-3, and then stores telephone number information, each port information and IP address information of each of the IP terminals 10-1, 10-2 and 10-3 in the terminal information table 32a shown in FIG. 7.

That is, the terminal information manager 31a recognizes the private ID information, the telephone number information and port type information of the first IP terminal 10-1 from the data field (f) of each link test message received from the first router 40, public IP address information set up in the source IP address field (b), and each port information set up in the source port field (d), and then manages them in the terminal information table 32a (S20).

Furthermore, the switching system 30 manages the private information table 32b in which private port information used in each of the private networks 51 and 52 is stored (S30).

For example, the switching system 30 manages the private port information which can be used in the private networks 51 and 52 assigned with the private ID information and public IP address information, that is, signaling port information, voice packet port information and video packet port information, and private IP address information used by the IP terminals 10-1, 10-2 and 10-3 connected to the corresponding private networks 51 and 52 using the private information table 32b.

The following description concerns the case where the first IP terminal 10-1 is a calling IP terminal and the second IP terminal 10-2 is a receiving IP terminal.

The first IP terminal 10-1 transmits a call request message to set up a voice call to the second IP terminal 10-2 according to a user selection (S40).

The controller 12 of the first IP terminal 10-1 transmits to the switching system 30 a call request signal including telephone number information of the second IP terminal 10-2 of “3200” as receiving telephone number information according to an input signal provided from the user interface 11.

The first IP terminal 10-1 transmits the call request message including the private ID information of the first private network 51, and the first router 40-1 converts the source IP address information of the received call request message from the private IP address information into the public IP address information. The destination IP address information can be the public IP address information of the switching system 30.

The switching system 30 recognizes the private ID information of the first IP terminal 10-1 that is the calling IP terminal in the received call request message and transmits it to the second IP terminal 10-2 of the receiving IP terminal based on the receiving telephone number information (S50).

The receiving IP terminal 10-2 transmits the call request message received from the switching system 30 including the private ID information connected to a response message to the call request message (S60).

The switching system 30 can transmit the call request message to the receiving IP terminal 10-2 using the public IP address information and public port information of the receiving IP terminal 10-2 stored in the terminal information table 32b.

The switching system 30 compares the private ID information included in the response message that is received from the receiving IP terminal 10-2 with the private ID information of the calling IP terminal 10-1 recognized in the call request message.

When the private ID information of the receiving IP terminal 10-2 and the private ID information of the calling IP terminal 10-1 are different from each other, the switching system 30 transmits the public IP address information and public port information of the calling IP terminal 10-1 to the receiving IP terminal 10-2, and the public IP address information and public port information of the receiving IP terminal 10-2 to the calling IP terminal 10-1.

When the private ID information of the calling IP terminal 10-1 and the private ID information of the receiving IP terminal 10-2 are the same, the switching system 30 determines that the calling IP terminal 10-1 and the receiving IP terminal 10-2 are connected to the same private network.

When each of the IP terminals 10-1 and 10-2 are connected to the same private network 51, the switching system 30 transmits to each of the IP terminals 10-1 and 10-2 an information provision message including the private IP address information and private port information used in the corresponding private network 51 (S70).

The switching system 30 searches for private IP address information and each private port information corresponding to the private ID information in the private information table 32b that stores the private IP address information and each private port information used by each of the IP terminals 10-1 and 10-2 connected to each of the private networks 51 and 52, as shown in FIG. 8.

Furthermore, the switching system 30 generates an information provision message including the searched private IP address information and private port information and transmits them to the receiving IP terminal 10-2 and the calling IP terminal 10-1. That is, the information provision message including the private IP address information and private port information of the receiving IP terminal 10-2 is transmitted to the calling IP terminal 10-1, and the information provision message including the private IP address information and private port information of the calling IP terminal 10-2 is transmitted to the receiving IP terminal 10-2.

Since the switching system 30 has to transmit the voice packet port information and video packet port information to each of the IP terminals 10-1 and 10-2, after generating a first information provision message including the voice packet port information and a second information provision message including the video packet port information, or generating an information request message including the voice packet port information and the video port information, it can transmit the information to each of the IP terminals 10-1 and 10-2.

The switching system 30 sets up the source IP address information and port information of each information request message transmitted to the calling IP terminal 10-1 or receiving IP terminal 10-2 as public IP address information and public port information, and the destination IP address information and port information as the public IP address information and public port information of the private networks 51 and 52 connected to each of the IP terminals 10-1 and 10-2. The switching system 30 sets up the private IP address information and private port information in the data field (d).

Furthermore, the first router 40 adjacent to each of the IP terminals 10-1 and 10-2 converts the public IP address information and public port information of the received information provision message into the private IP address information and private port information, and then transmits them to each of the IP terminals 10-1 and 10-2.

Each of the IP terminals 10-1 and 10-2 recognizes the private IP address information and private port information included in the received information request message, sets up the recognized information as a destination address of the generated packet, and then exchanges the packet with the opposite IP terminal 10-1 or 10-2 connected to the same private network 51 or 52 (S80).

That is, each of the IP terminals 10-1 and 10-2 can set up the private IP address information and private port information included in the information provision message that is received from the switching system 30 as destination information of the generated packet, and directly exchange the information with the opposite IP terminal 10-1 or 10-2 connected to the same private network 51.

When the call request message received from the calling IP terminal 10-1 through the first router 40-1 does not include the private ID information, the switching system 30 determines whether or not the public IP address information that is the source ID address information of the call request message and the public IP address information corresponding to the receiving telephone number information are the same.

When the public IP address information of the calling IP terminal 10-1 and the public IP address information of the receiving IP terminal 10-2 are the same, the switching system 30 determines that the calling IP terminal 10-1 and the receiving IP terminal 10-2 are connected to the same private network 51. The calling IP terminals 10-1 searches for the private IP address information and private port information used in the private network 51 from the private information table 32b, includes the searched information in the call request message, and then transmits them to the receiving IP terminal 10-2.

Furthermore, the receiving IP terminal 10-2 recognizes the private IP address information and private port information from the call request message and then transmits a response message to the call request message to the switching system 30.

The switching system 30 includes the searched private IP address information and private port information in the received response message and transmits the message to the calling IP terminal 10-1 so that each of the IP terminals 10-1 and 10-2 enables the opposite IP terminal 10-1 or 10-2 to recognize the private IP address information and private port information used in the private network 51.

The switching system 30 can transmit to the receiving IP terminal 10-2 and the calling IP terminal 10-1 the call request message and the response message including both the voice packet port information and the video packet port information used by each of the IP terminals 10-1 and 10-2, or transmit the voice packet port information and the video packet port information to each of the IP terminals 10-1 and 10-2 through a separate message after transmitting the call request message and the response message.

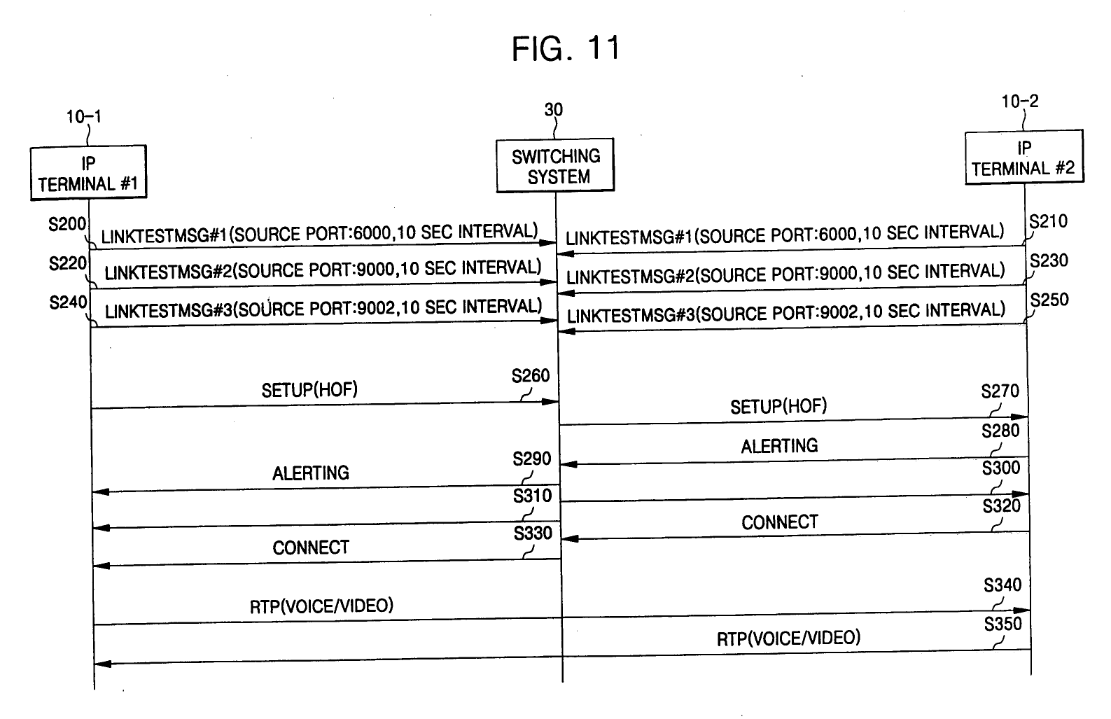

FIG. 11 is a view of a method of providing an Internet telephone service according to an exemplary embodiment of the present invention. Referring to FIG. 11, when each of the IP terminals 10-1 and 10-2 is connected to the IP network, it transmits to the switching system 30 a first link test message (LinkTestMsg #1) including signaling port information and private ID information to set up a voice call, a second link test message (LinkTestMsg #2) including voice packet port information and private ID information to exchange a voice packet, and a third link test message (LinkTestMsg #3) including video packet port information and private ID information to exchange a video packet with a predetermined period (S200, S210, S220, S230, S240 and S250).

Each of the routers 40-1 and 40-2 connected to each of the private networks 51 and 52 converts private IP address information and port information of the private networks 51 and 52 set up in a source IP address field (b) and a source port field (d) of each link test message (LinkTestMsg) received from each of the IP terminals 10-1 and 10-2 into corresponding public IP address information and port information of the public network 60, and then transmits them to the switching system 30.

The switching system 30 recognizes telephone number information, private IP address information, public IP address information, private ID information and each port information included in each link test message received from each of the IP terminals 10-1 and 10-2 and manages them using the terminal information table 32a as shown in FIG. 7.

If a user wishes to use an Internet telephone service to call the second IP terminal 10-2 using the first IP terminal 10-1, the first IP terminal 10-1 generates a call request message (Setup) in which telephone number information of the second IP terminal 10-2 is set up as receiving telephone number information according to the user selection and which includes the assigned private ID information, and then transmits the message to the switching system 30 (S260).

The switching system 30 recognizes the private ID information from the received call request message, and then transmits the call request message to the receiving IP terminal 10-2 (S270).

When the receiving IP terminal 10-2 receives the call request message, it transmits a response message (Alerting) including the assigned private ID information to the switching system 30, and the switching system 30 transmits the response message to the calling IP terminal 10-1 (S280 and S290).

When the private ID information included in the received response message and the private ID information of the calling IP terminal 10-1 are the same, the switching system 30 determines that each of the IP terminals 10-1 and 10-2 is connected to the same private network 51, and searches for the private port information and private IP address information of each of the IP terminals 10-1 and 10-2 connected to the corresponding private network 51.

Furthermore, the switching system 30 generates an information provision message including the searched private IP address information and private port information, and transmits the message to the receiving IP terminal 10-2 while transmitting it to the calling IP terminal 10-1.

Since the switching system 30 has to transmit voice packet port information and video packet port information to each of the IP terminals 10-1 and 10-2, it can generate a first information provision message including the voice packet port information and a second information provision message including the video packet port information and then transmit the messages to each of the IP terminals 10-1 and 10-2, or generate an information request message including the voice packet port information and the video port information and then transmit the message to each of the IP terminals 10-1 and 10-2.

Furthermore, an information provision message including the private IP address information used by the receiving IP terminal 10-2 in the private network 51 is transmitted to the calling IP terminal 10-1, and an information provision message including the private IP address information used by the calling IP terminal 10-1 in the private network 51 is transmitted to the receiving IP terminal 10-2.

Since the switching system 30 received the response message from the receiving IP terminal 10-2, it sets up a voice call between the receiving IP terminal 10-2 and the calling IP terminal 10-1 (S320 and S330).

Each of the IP terminals 10-1 and 10-2 exchanges the packet using the private IP address information and private port information of the opposite IP terminal 10-1 or 10-2 recognized through the information provision message (S370 and S380).

That is, when the voice call is set up, each of the IP terminals 10-1 and 10-2 transmits the voice packet based on a voice signal using the private IP address information and voice packet port information of the opposite IP terminal 10-1 or 10-2, and directly transmits the video packet based on a video signal using the private IP address information and video packet port information of the opposite IP terminal 10-1 or 10-2 without passing through the switching system 30.

As described above, in accordance with the present invention, when the voice call is set up between the IP terminals connected to the same private network, the packet can be directly exchanged in the private network through the private IP address information and private port information of the opposite IP terminal, so that a transmission delay of the packet can be minimized while maximizing efficiency of resource use in the IP network.

While the present invention has been described with reference to an exemplary embodiment thereof, it will be understood by those skilled in the art that various changes in form and details may be made therein without departing from the spirit and scope of the present invention as defined by the following claims.

What is claimed is:

1. A system, comprising:
a first IP terminal adapted to transmit a call request message including identification information assigned to a connected private network, and to exchange a packet according to either address information or port information included in a received information provision message;
a second IP terminal adapted to transmit a response message including the identification information assigned to the connected private network to a switching server, and to exchange a packet according to either the address information or port information included in the information provision message, in response to receiving the call request message; and
the switching server adapted to transmit the information provision message including either the address information or port information to each IP terminal upon the identification information included in the call request message and the identification information included in the response message being the same, while managing the identification information assigned to each private network, and managing either address information or port information used upon each IP terminal exchanging the packet.

2. The system according to claim 1, further comprising at least one router adapted to convert either private address information or private port information included in the packet received from the private network into corresponding public address information or public port information, and to convert either public address information or public port information included in the packet received from a public network into corresponding private address information or private port information.

3. The system according to claim 1, wherein each IP terminal comprises:
a memory adapted to store the address information assigned in the network, the port information to exchange the packet, and the identification information assigned to the connected private network;
a message processor adapted to transmit a test message to the switching server using the address information, the port information and the identification information stored in the memory, and to transmit the response message to the call request message received from the switching server after including the stored identification information in the response message; and
a packet processor adapted to set up either address information or port information of an opposite IP terminal recognized in the information provision message received from the switching server as destination information of a generated packet.

4. The system according to claim 3, wherein the message processor is adapted to generate at least one test message including either the port information, the address information or the identification information stored in the memory and to transmit the test message to the switching server.

5. The system according to claim 3, wherein the packet processor is adapted to set up the destination information of the packet as either the address information or port information of the opposite IP terminal received from the switching server, and to set up the source information as either the address information or port information assigned in the connected private network.

6. The system according to claim 3, further comprising:
a user interface adapted to provide either a telephone number signal or voice signal based on a user's selection, and to output voice information based on the received voice signal;
a video processor adapted to provide a video signal based on video information to be photographed, and to display video information based on the received video signal, in response to a voice call being set up to the opposite IP terminal; and
a controller adapted to generate a packet based on either the provided voice signal or video signal, and to transmit the voice signal or video signal included in the packet received from the opposite IP terminal to the user interface or video processor.

7. The system according to claim 1, wherein the switching server comprises:
a database adapted to store telephone number information of each IP terminal, identification information solely assigned to each private network, and private address information and private port information used in the private network; and
an information transmitter adapted to transmit either the private address information or private port information of the second IP terminal to the first IP terminal and either the private address information or private port information of the first IP terminal to the second IP terminal upon the identification information included in the call request message received from the first IP terminal and the identification information included in the response message received from the second IP terminal being the same.

8. The system according to claim 7, wherein the information transmitter is adapted to transmit a first information provision message including either the private address information or private port information of the first IP terminal to the second IP terminal and a second information message including either the private address information or private port information of the second IP terminal to the first IP terminal, upon the identification information of the first IP terminal included in the call request message and the identification information included in the response message received from the second IP terminal being the same.

9. The system according to claim 7, wherein the information transmitter is adapted to transmit the information provision message to the first and second IP terminals, upon the public address information set as source address information of the call request message received from the first IP terminal and public address information corresponding to the receiving telephone number information being the same.

10. The system according to claim 1, wherein the address information comprises at least one of the private IP address information used in each private network and the public IP address information used in the public network.

11. The system according to claim 1, wherein the port information comprises at least one of signaling port information for exchanging a signaling packet to set up a voice call, voice packet port information for exchanging a voice packet of voice information, and video packet port information for exchanging a video packet of video information.

12. The system according to claim 1, wherein the switching server is connected to one of a plurality of private networks that are connected to each IP terminal.

13. A switching server of a network including at least one IP terminal connected to a public network through a plurality of private networks, the switching server comprising:
a database adapted to store telephone number information, identification information, public address information, private address information, each port information, and private address information and private port information corresponding to identification information of each private network of each IP terminal connected through each private network; and
an information transmitter adapted to transmit a call request message received from a first IP terminal to a second IP terminal, and to transmit an information provision message including private address information and private port information corresponding to the identification information of each IP terminal to each IP terminal upon the identification information of the first IP terminal and the identification information of the second IP terminal being the same.

14. A method of providing a service in a packet communication system including at least one IP terminal connected to a public network through private networks that are different from one another and a switching server, the method comprising:
managing, at the switching server, identification information of each private network and either address information or port information of each IP terminal using an information table;
recognizing, at the switching server, identification information from a call request message received from a first IP terminal, and then transmitting the identification information to a second IP terminal;
transmitting, at the second IP terminal, a response message to the received call request message including identification information of the connected private network to the switching server; and
transmitting, at the switching server, either the address information or port information of the second IP terminal to the first IP terminal while transmitting either the address information or port information of the first IP terminal to the second IP terminal, upon the identification information of the first IP terminal and the identification information of the second IP terminal being the same.

15. The method according to claim 14, wherein the address information comprises at least one of private IP address information used in each private network and public IP address information used in the public network.

16. The method according claim 14, wherein the port information comprises at least one of signaling port information for exchanging a signaling packet to set up a voice call, voice packet port information for exchanging a voice packet of voice information, and video packet port information for exchanging a video packet of video information.

17. The method according to claim 14, further comprising:
generating, at each IP terminal, a test message including private address information, private port information and identification information assigned from the connected private network, and then transmitting the test message to the network;
converting the private information and private port information included in the test message into corresponding public address information and public port information, and transmitting the converted information to the switching server; and
generating, at the switching server, an information table based on the address information, the port information and the identification information of each IP terminal included in the test message.

18. The method according to claim 14, further comprising:
generating, at the switching server, a first information provision message including either the private address information or private port information of the first IP terminal, and transmitting the message to the second IP terminal, upon the identification information of the first IP terminal and the identification information of the second IP terminal being the same; and
generating, at the switching server, a second information provision message including either the private address information or private port information of the second IP terminal, and transmitting the message to the first IP terminal.

19. The method according to claim 14, further comprising:
recognizing, at the switching server, the address information of the first IP terminal included in the received call request message;
recognizing the address information of the second IP terminal based on a receiving telephone number of the call request message;
searching for private address information or private port information corresponding to the address information of the first IP terminal or the second IP terminal upon the address information of the first IP terminal and the address information of the second IP terminal being the same; and
generating an information provision message including the searched private address information or private port information, and transmitting the message to each IP terminal.

20. The method according to claim 19, wherein the address information comprises public IP address information used by each IP terminal in the public network.
